(19) United States
(12) Patent Application Publication
(10) Pub. No.: US 2005/0238884 A1
(43) Pub. Date: Oct. 27, 2005

(54) Urethane acrylate composition structure

(76) Inventors: David D. Peters, Wyandotte, MI (US); Calvin T. Peeler, Canton, MI (US); Joseph Ogonowski, Newport, MI (US); David Kielbasa, Oak Park, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/955,369

(22) Filed: Sep. 30, 2004

Related U.S. Application Data
(63) Continuation-in-part of application No. 10/832,903, filed on Apr. 27, 2004.
(63) Continuation-in-part of application No. 10/935,549, filed on Sep. 7, 2004.
(63) Continuation-in-part of application No. 10/935,437, filed on Sep. 7, 2004.

(51) Int. Cl. B32B 27/00

(52) U.S. Cl. 428/423.1

(57) ABSTRACT

A composite structure includes a first layer and a support layer. The first layer is a show surface of the composite structure and is preformed from a polymer. The support layer includes a urethane acrylate composition that includes a urethane acrylate adduct. The urethane acrylate adduct is the reaction product of an isocyanate component and a stoichiometric excess of a functionalized acrylate component. The isocyanate component has at least two isocyanate groups. The functionalized acrylate component has at least one isocyanate-reactive functional group that is reactive with at least one of the isocyanate groups for forming the urethane acrylate adduct. The urethane acrylate composition also includes a catalyst system including a peroxide and a first metal salt. The resulting urethane acrylate composition is sufficiently low in viscosity for many processing applications, and the support layer including the urethane acrylate composition exhibits sufficient adhesion to the first layer.

### RELATED APPLICATIONS

This application is a continuation-in-part of co-pending U.S. patent application Ser. No. 10/832,903, filed on Apr. 27, 2004, Ser. No. 10/935,437, filed on Sep. 7, 2004, and Ser. No. 10/935,549, filed on Sep. 7, 2004.

### FIELD OF THE INVENTION

The present invention generally relates to a composite structure. The composite structure includes a first layer, which is a show surface of the composite structure, and a support layer. The support layer includes a urethane acrylate composition. The composite structure is primarily utilized to replace current fiberglass reinforced polyester (FRP) composites and polyurethane-based composites used in the composite industry.

### BACKGROUND OF THE INVENTION

Use of composite structures is known in the art, as are composite structures including a first layer and a support layer. The first layer, also referred to as a show or wear surface, is typically a styrenated polyester layer; however, acrylic polymers and styrenic copolymers have also been included in such show surfaces for the composite structures. Methods of forming the show surface are also known, such as spraying or thermoforming the show surface onto a surface of a mold or die to create a desired surface.

Typically, the support layer is formed from either a fiberglass reinforced polyester (FRP) or a reinforced polyurethane. The support layer functions to provide structural integrity and durability to the complete composite structure and can be made up of multiple layers of the composite material encapsulating various inserted material, such as fiberglass, wood, expanded metal sheets, cardboard honey comb, urethane materials, plastic materials, and plate metal sheets and/or pieces. However, both the FRP and the polyurethane-based support layers present deficiencies during the manufacturing process. These deficiencies result in, but are not limited to, increased cost of production, inconsistent quality, environmental, health, and safety issues, or combinations of these problems.

For example, when the FRP support layer is used, large quantities of styrene monomer and other volatile organic compounds (VOC) are emitted. The emission of VOCs may present environmental, health, and safety issues, and is thus undesirable. As a result of the quantities of VOCs associated with the composite structures of the prior art, the Environmental Protection Agency (EPA) is placing restrictions on the composite industry to reduce or eliminate the emissions.

One deficiency of the polyurethane-based support layers is that they are sensitive to moisture during production. The isocyanate component of the polyurethane-based support layer will react with moisture, which alters the reactivity of the isocyanate component and causes micro and/or macro cellular foaming in the final composite structure. As a result, inconsistent quality of the polyurethane-based support layer is a potential issue. Many of the common components in the polyurethane-based support layer, such as wood, cardboard, and other fibers, are particularly problematic since these materials generally contain moisture. This presents a problem for the building supplies industry, for which composite structures including wood fibers are particularly useful.

Urethane acrylates have been developed in the prior art for use in coating systems, with limited use in composite structure applications. The urethane acrylates are the reaction product of an isocyanate component and a functionalized acrylate component that is reactive with the isocyanate component. The urethane acrylates are less sensitive to moisture, as compared to the composite structures including the polyurethane-based support layer. However, the urethane acrylates of the prior art are not suitable for use in many composite structure applications because of resin stability limitations, viscosity, and cost.

For example, U.S. Pat. No. 6,509,086 discloses a composite structure having a show surface and a support layer. The show surface is formed from an acrylic polymer and may be formed through a thermoforming process in a mold. The support layer is formed from a composition that includes up to 50 parts by weight of urethane acrylate, based on the total weight of the composition. The composition is applied to the back side of the show surface while the show surface is in the mold. The urethane acrylate is the reaction product of isophorone diisocyanate, i.e., the isocyanate component, and a stoichiometric amount of 2-hydroxyethyl methacrylate (HEMA), i.e., the functionalized acrylate component. The '086 patent does not disclose other compositions for the show surface besides the acrylic polymer and the components in the support layer are not optimized to maximize adhesion between the layer. Furthermore, the composition is not optimized for desirable gel times. As a result, other compositions of the first layer may not sufficiently adhere to the urethane acrylate disclosed in the '086 patent.

Due to the deficiencies of the prior art, including those described above, it is desirable to provide a novel composite structure having a first layer that is a show surface of the composite structure backed by a support layer formed from a urethane acrylate that is sufficiently low in viscosity to enable spray application during the production of the composite structure and that sufficiently adheres to the first layer to prevent delamination of the layers.

### SUMMARY OF THE INVENTION AND ADVANTAGES

The subject invention provides a composite structure. The composite structure includes a first layer and a support layer. The first layer is a show surface of the composite structure and is preformed from a polymer. The support layer includes a urethane acrylate composition including a urethane acrylate adduct that is the reaction product of an isocyanate component and a stoichiometric excess of a functionalized acrylate component. More specifically, the isocyanate component has at least two isocyanate groups, and the functionalized acrylate component has at least one isocyanate-reactive functional group that is reactive with at least one of the isocyanate groups. The urethane acrylate composition further includes a catalyst system including a peroxide and a first metal salt.

The urethane acrylate composition has an intrinsically low viscosity, which is responsible in part for lower VOC emissions than typical styrenated polyester or vinyl ester resins. More specifically, the urethane acrylate composition has a sufficiently low viscosity absent additional reactive diluents, which the prior art compositions require and which result in higher VOC emissions. Furthermore, the urethane acrylate adduct has a more balanced reaction profile, as compared to the prior art compositions, and forms less oligomers prior to generation of heat during reaction of the isocyanate component and the functionalized acrylate component. Further, the viscosity of the urethane acrylate composition is sufficiently low for many spray applications due to the stoichiometric excess of the functionalized acrylate component. The urethane acrylate adduct is not reactive with water, unlike the prior art compositions including a polyurethane-based support layer, and is therefore not as sensitive to moisture during spray applications. This results in more consistent physical properties of the composite structure. Further, depending on a chemical composition of the show surface, the urethane acrylate adduct may react with the polymer in the show surface to yield a stronger cohesive bond without the use of adhesion promoters as is required in the prior art composite structures.

### DETAILED DESCRIPTION OF A PREFERRED EMBODIMENT

A composite structure according to the subject invention includes a first layer and a support layer. Ultimately, the first layer is a show surface of the composite structure. The support layer includes a urethane acrylate composition. The urethane acrylate composition includes a urethane acrylate adduct, which is the reaction product of an isocyanate component and a functionalized acrylate component that is reactive with the isocyanate component, to be described in further detail below. The support layer provides structural integrity and durability to the complete composite structure. As such, the support layer is preferably at least 0.04 inches thick, based on the physical requirements of the final composite structure. In one embodiment, the composite structure further includes a second layer disposed between the first layer and the support layer. Preferably, the second layer is formed from a second urethane acrylate adduct that may be the same as or different from the urethane acrylate adduct of the support layer. However, it is to be appreciated that the second layer may be formed from other polymers, such as polydicyclopentadiene. The second layer is disposed between the first layer and the support layer and has improved properties such as, but not limited to, wetting and de-aeration for improving adhesion to the first layer, minimal shrinkage and porosity, and maximized impact resistance. The second layer will be described in further detail below.

The first layer is formed through a preforming process. One example of a performing process is a thermoforming process, which is known to those of skill in the art. The support layer is formed on the first layer to form the composite structure.

The urethane acrylate composition has sufficiently low viscosity to enable spraying of the urethane acrylate composition during production of the composite structure. It is to be appreciated that the urethane acrylate composition may be poured or injected; however, spraying is the preferred manufacturing process for composite structures due, in part, to the cost of processing equipment.

Preferably, fibers are included in the support layer to reinforce the composite structure, to minimize or eliminate crack propagation, and to provide structural integrity to the composite structure. If included, the fibers include, but are not limited to, chopped fiberglass, chopped carbon fibers, chopped wood fibers, chopped aramid fibers including all aromatic polyamide materials, chopped polymer fibers such as nylon, cellulose fibers, polyacrylonitrile fibers, polyurethane fibers, and polyester fibers based on aromatic and/or aliphatic dicarboxylic acid esters, and in particular, carbon fibers, and combinations thereof. In a most preferred embodiment, the fiber is chopped glass. Preferably, the support layer with the fiber is rolled to eliminate entrained and otherwise trapped air, resulting in a layer of densified material. In another embodiment, the support layer without fiber is applied thinly to the first layer. Fiber is then applied onto the support layer. The support layer with the fiber is then rolled. However, it is to be appreciated that the composite structure may be produced without the fiber given that the non-reinforced composite structure yields the desired physical and functional properties.

After application of the first layer and the support layer, and also after removing the completed composite structure, the first layer is a show surface of the composite structure whereas the support layer is a backing layer to the first layer. In addition to fiber, other fillers may also be included in the support layer. The filler in the support layer may provide pigmentation, flame retardance, insulation, and reduced cost of the composite structure. Suitable fillers for the support layer include conventional organic and inorganic fillers. More specific examples include, but are not limited to, inorganic fillers, such as silicate minerals, for example, both hollow and solid glass beads, phyllosilicates such as antigorite, serpentine, hornblends, amphiboles, chrysotile, and talc; metal oxides, such as aluminum oxides, titanium oxides and iron oxides; metal salts, such as chalk, barite and inorganic pigments, such as cadmium sulfide, zinc sulfide and glass, inter alia; kaolin (china clay), and aluminum silicate and co-precipitates of barium sulfate and aluminum silicate. Examples of suitable organic fillers include, but are not limited to, carbon black and melamine. In a preferred embodiment, the filler is calcium carbonate.

The inorganic and organic fillers may be used individually or as mixtures and are blended into the urethane acrylate composition in amounts of less than or equal to 65 parts by weight, more preferably less than or equal to 55 parts by weight, most preferably from 30 to 45 parts by weight, based on the total weight of the support layer.

Various polymers may be included in the first layer, depending on the desired properties of the first layer. In one embodiment, the polymer of the first layer includes a copolymer. More specifically, the copolymer is preferably selected from, but not limited to, the group of styrene acrylonitrile, acrylonitrile styrene acrylate, acrylonitrile styrene alkacrylates, poly(acrylonitrile-co-alkyl acrylate), poly(acrylonitrile-co-alkyl alkacrylate), and combinations thereof. In another embodiment, the polymer of the first layer is based on at least one of an acrylonitrile and an acrylate. More specifically, the polymer is selected from, but not limited to, the group of acrylonitrile butadiene styrene, polyalkyl acrylate, polyalkyl alkacrylate, and combinations thereof. In another embodiment, the polymer may be an acrylic polymer, which is commonly used for show surfaces in bathware.

As stated above, the urethane acrylate composition includes the urethane acrylate adduct, which is the reaction product of the isocyanate component and the functionalized acrylate component. More specifically, the isocyanate component has at least two isocyanate groups, which provide polymeric functionality to the urethane acrylate adduct. In a preferred embodiment, the isocyanate component has from two to three isocyanate groups.

Preferably, the isocyanate component is selected from the group of toluene diisocyanates, polymeric diphenylmethane diisocyanates, diphenylmethane diisocyanates, and combinations thereof. In a most preferred embodiment, the isocyanate component is a polymeric diphenylmethane diisocyanate. Specific examples of preferred isocyanate components suitable for the urethane acrylate of the support layer include, but are not limited to, Lupranate® M20S Isocyanate® Lupranate® MI Isocyanate, Lupranate® M70R Isocyanate, Lupranate® M200 Isocyanate, ELASTOFLEX® R23000 Isocyanate, and Lupranate® T-80 Isocyanate. All are commercially available from BASF Corporation of Wyandotte, Mich. As alluded to above, the isocyanate component may include a combination of isocyanates. That is, a blend of at least two isocyanates may be utilized for reaction with the functionalized acrylate component to form the urethane acrylate adduct.

Other suitable isocyanate components include, but are not limited to, conventional aliphatic, cycloaliphatic, araliphatic and aromatic isocyanates. Specific examples include: hexamethylene diisocyanate (HDI), hexamethylene diisocyanate trimer (HDI Trimer), hexamethylene diisocyanate biuret (HDI Biuret), isophorone diisocyanate (IPDI), isophorone diisocyanate trimer (IPDI Trimer), dicyclohexane-4,4′-diisocyanate, cyclohexane diisocyanate, meta-tetramethylxylene diisocyanate (TMXDI), alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane(isophorone diisocyanate), 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures, aromatic diisocyanates such as 2,4- and 2,6-toluene diisocyanate and the corresponding isomeric mixtures, 4,4′-, 2,4′-, and 2,2′-diphenylmethane diisocyanate and the corresponding isomeric mixtures, as well as mixtures of any of the aforementioned isocyanate components.

Additionally, it is to be understood that the isocyanate component may be an isocyanate terminated quazi-prepolymer or otherwise modified isocyanate prepared from the aforementioned isocyanates or combinations of isocyanates. More specifically, the isocyanate component may include any of the aforementioned isocyanates and a stoichiometrically insufficient amount of a polyhydroxyl compound such as, but not limited to, polyether polyol and/or polyester-based polyols, polyhydroxy olefinic, or acrylate-substituted species. Further, the polyhydroxy olefinic or acrylate-substituted species of these prepolymers may include at least one isocyanate-reactive functional group that is reactive with the isocyanate component and at least one reactive acrylate or olefinic group. The prepolymer may then be further reacted with a second functionalized acrylate component to fully react all remaining free isocyanate groups of the prepolymer described above.

The functionalized acrylate component as set forth above has at least one isocyanate-reactive functional group that is reactive with at least one of the isocyanate groups. Preferably, the functionalized acrylate component has from one to four isocyanate-reactive functional groups. In a most preferred embodiment, the functionalized acrylate component has one isocyanate-reactive functional group which, when reacted with the isocyanate component, provides sufficiently low viscosity, to be discussed in further detail below, to enable processing of the urethane acrylate composition during the production of the composite structure.

Preferably, the isocyanate-reactive functional groups are selected from the group of hydroxy-functional groups, amine-functional groups, and combinations thereof. Suitable hydroxy-functional groups include hydroxy-functional alkyl groups having from one to twenty carbon atoms. Specific examples of functionalized acrylate components including suitable hydroxy-functional groups include, but are not limited to, hydroxymethyl, hydroxyethyl, hydroxypropyl, and hydroxybutyl acrylates and alkacrylates, and combinations thereof. It is to be appreciated that the acrylates may include more than one of the aforementioned hydroxy-functional groups and may be incorporated as a prepolymer as described above.

Preferably, the hydroxy-functional group of the functionalized acrylate component includes an alkacrylate unit that has at least one alkyl group having from one to twenty carbon atoms. Specific examples of functionalized acrylate components including suitable alkacrylate groups include, but are not limited to, methacrylates, ethacrylates, propacrylates, butacrylates, phenylacrylates, methacrylamides, ethacrylamides, butacrylamides, and combinations thereof. Preferred functionalized acrylate components include hydroxymethyl methacrylate, hydroxyethyl methacrylate, hydroxypropyl methacrylate, hydroxymethyl ethacrylate, hydroxyethyl ethacrylate, hydroxypropyl ethacrylate, glycerol dimethacrylate, N-methylol methacrylamide, 2-tert-butyl arninoethyl methacrylate, dimethylaminopropyl methacrylamide, and combinations thereof. In a most preferred embodiment, the functionalized acrylate component is a hydroxyethyl methacrylate. Further, it is to be appreciated that the functionalized acrylate component may include substituted acrylates such as, but not limited to, hydroxyethyl acrylate and hydroxymethyl acrylate.

As stated above, the functionalized acrylate component is provided in a stoichiometric excess with respect to the isocyanate component. The excess functionalized acrylate component functions as a reactive diluent, which lowers the viscosity of the urethane acrylate composition. Preferably, the stoichiometric excess of the functionalized acrylate component is defined as a range of molar equivalent ratios of the functionalized acrylate component to the isocyanate component of from 3:1 to 1.05:1. More preferably, the stoichiometric excess is defined as a range of molar equivalent ratios of from 2.5:1 to 1.05:1. In a most preferred embodiment, the stoichiometric excess is defined as a range of molar equivalent ratios of the functionalized acrylate component to the isocyanate component of from 2:1 to 1.05:1. The actual amounts by weight of the functionalized acrylate component and the isocyanate component will vary depending on the specific acrylate or mixture of acrylates used, as well as with the specific isocyanate component used. Further, the choice of the specific isocyanate and acrylate components will affect the resultant viscosity of the urethane acrylate composition.

Alternatively, an additional reactive diluent may be included in the urethane acrylate composition including the urethane acrylate adduct to further lower the viscosity of the urethane acrylate composition and/or modify the physical properties of the final composite structure. The reactive diluent has at least one acrylate-reactive functional group selected from, but not limited to, the group of vinyl, allyl, cyclic allyl, cyclic vinyl, acrylic, functionalized acrylic, acrylamides, acrylonitrile, and combinations thereof. Specific examples of reactive diluents that are suitable for the subject invention include, but not limited to styrene, divinyl benzene, allyl alkylacrylates, vinyl toluene, diacetone acrylamide, acrylonitrile, methyl methacrylate, hydroxyethyl methacrylate, hydroxypropyl methacrylate, alpha methyl styrene, butyl styrene, monochlorostyrene, and combinations thereof. Preferably, the weight ratio of the reactive diluent to the urethane acrylate adduct is at least 0.01:1. More preferably, the weight ratio of the reactive diluent to the functionalized acrylate component is from 0.1:1 to 1:1. In terms of actual amounts by weight, the reactive diluent is preferably present in an amount of at least 1.0 part by weight, more preferably from 1.0 to 50 parts by weight, most preferably from 5 to 40 parts by weight based on the total weight of the total composition.

The viscosity of the urethane acrylate composition including the urethane acrylate adduct, the reactive diluent, and the optional fillers and additives where applicable, must be sufficiently low to enable spray application during the production of the composite structure. The viscosity of the urethane acrylate composition is from 800 to 55000 centipoise at 77° F., as measured on a Brookfield® RVT viscometer at 10 rpm. Preferably, the urethane acrylate composition absent fillers has a viscosity of from 50 to 3000 centipoise, more preferably from 100 to 300 centipoise, most preferably from 150 to 250 centipoise, at 77° F. Lower viscosities within the above-stated ranges are required as the amount of filler present in the composition is increased. Resulting viscosities of the support layer including the filler may be up to 60,000 centipoise at 77° F. with a thixotropic index of from 2.4 to 10.

The support layer, more specifically the urethane acrylate composition, further includes a catalyst system. Generally, the catalyst system catalyzes a free radical reaction of the urethane acrylate composition. More specifically, it catalyzes the free radical reaction of an unsaturated functionality of the urethane acrylate composition with another unsaturated functionality of the urethane acrylate composition and/or of the reactive diluent to form the composite article. It is contemplated that the reactive diluent includes the excess functionalized acrylate component. The catalyst system also allows the urethane acrylate composition to cure at room temperature within a short period of time.

The catalyst system includes a peroxide-based catalyst. Without intending to be bound or limited by any particular theory, it is believed that the peroxide-based catalyst serves as a source of free radicals through an interaction with an accelerator, described further below. The free radicals generated allow polymerization to occur via a free-radical polymerization mechanism. Preferably the peroxide-based catalyst includes, but is not limited to, an organic peroxide. Specific examples of suitable peroxide-based catalysts include dibenzoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumene hydroperoxide, paramenthane hydroperoxide, diacetyl peroxide, di-alpha-cumyl peroxide, dipropyl peroxide, diisopropyl peroxide, isopropyl-t-butyl peroxide, butyl-t-butyl peroxide, difuroyl peroxide, bis(triphenylmethyl)peroxide, bis(p-methoxybenzoyl)peroxide, p-monomethoxybenzoyl peroxide, rubene peroxide, propyl hydroperoxide, isopropyl hydroperoxide, n-butyl hydroperoxide, t-butyl hydroperoxide, cyclohexyl hydroperoxide, trans-decalin hydroperoxide, alpha-methylbenzyl hydroperoxide, alpha-methyl-alpha-ethyl benzyl hydroperoxide, tetralin hydroperoxide, triphenylmethyl hydroperoxide, diphenylmethyl hydroperoxide, benzoyl peroxide, and combinations thereof. In addition, photo-initiated and azo-based catalysts may also be suitable.

Preferably, the catalyst system includes a first metal salt. Without intending to be bound or limited by any particular theory, it is believed that the first metal salt interacts with a second metal salt, to be described in further detail below, and aids in an oxidative surface curing of the urethane acrylate composition. Preferably, the first metal salt includes, but is not limited to, a metal carboxylate. However, other metal salts that are not metal carboxylates are also contemplated for use herein. One example of another metal salt that is not a metal carboxylate is cobalt naphthenate. More preferably, the first metal salt includes an oxidizable transition metal carboxylate. Most preferably, the first metal salt includes cobalt carboxylate and is commercially available from OM Group Inc. of Cleveland, Ohio, under the trade name of 12% Cobalt Cem-All®. Preferably, the first metal salt is present in an amount of from 0.01 to 1.00, more preferably of from 0.05 to 0.75, and most preferably of from 0.10 to 0.50 parts by weight based on 100 parts by weight of the urethane acrylate composition.

Preferably, as set forth above, the catalyst system also includes the second metal salt. The second metal salt promotes a surface curing of the support layer in the final composite structure. Without intending to be bound or limited by any particular theory, it is believed that the second metal salt interacts with the first metal salt to help promote a ligand exchange or a formation of a coordination complex in oxidative curing of the first metal salt. Preferably, the second metal salt includes, but is not limited to, a metal carboxylate. Most preferably, the second metal salt includes potassium octoate and is commercially available from Air Products and Chemicals, Inc. of Allentown, Pa. under the trade name of DABCO® K-15. Preferably, the second metal salt is present in an amount of from 0.010 to 1.000, more preferably of from 0.025 to 0.500, and most preferably of from 0.050 to 0.250 parts by weight based on 100 parts by weight of the urethane acrylate composition.

Preferably, as set forth above, the catalyst system also includes the accelerator. Without intending to be bound or limited by any particular theory, it is believed that the accelerator forms a coordination complex with the second metal salt to increase a rate of peroxide decomposition, thus accelerating the free radical polymerization cross-linking in the urethane acrylate composition. Preferably, the accelerator is selected from the group of, but is not limited to, anilines, amines, amides, pyridines, and combinations thereof. However, other accelerators, such as acetylacetone, have also been contemplated for use in the subject invention. More preferably, the accelerator includes a dimethyl toluidine or a dialkyl aniline. Most preferably, the accelerator includes N,N-dimethyl-p-toluidine, N,N-diethylaniline, N,N-dimethylaniline, and combinations thereof. The most preferred accelerator is selected based on a desired gel time. N,N-dimethyl-p-toluidine is selected for fast gel times of less than 5 minutes. N,N-diethylaniline and N,N-dimethylaniline are selected for slower gel times of greater than 5 minutes. Preferably, the accelerator is present in an amount of from 0.01 to 0.50, more preferably of from 0.05 to 0.40, and most preferably of from 0.08 to 0.30 parts by weight based on 100 parts by weight of the urethane acrylate composition.

Depending on the selection of the peroxide-based catalyst, heat or other promotion techniques may also be required to promote and accelerate the initiation of the reaction. It is to be appreciated that other materials that function in combination with the above-mentioned metal salts and accelerators may also be used in the catalyst system.

Preferably, the total amount of the catalyst system present in the composition is from 0.02 to 7 parts by weight, more preferably from 0.5 to 5 parts by weight, based on the total weight of the urethane acrylate composition.

The second layer may further comprise an additive or additives. If included, the additive is selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, gel time retarders, and combinations thereof. Other suitable additives include, but are not limited to, hydrolysis-protection agents, fungistatic and bacteriostatic substances, dispersing agents, adhesion promoters, and appearance enhancing agents such as flow and wetting agents, pigments, and dyes. Each of these additives serves a specific function, or functions, within the second layer that are known to those skilled in the art.

The support layer and the first layer exhibit sufficient adhesion for bathware applications. More specifically, as described in further detail below in the Examples section, the adhesion between the first layer and the support layer is preferably at least 300 psi. It is to be appreciated that the thickness of the support layer may vary depending on the presence of the additional reactive diluents, which may enhance the adhesion between the layers.

The following examples, illustrating the composition of the first layer and the support layer, are intended to illustrate and not to limit the invention. The amounts set forth in these examples are by weight, unless otherwise indicated.

### EXAMPLES

Composite structures of the subject invention are formed including the first layer and the support layer. The first layer is preformed from the polymer indicated below in Table 1. The support layer is formed from a composition including the urethane acrylate adduct, among other components, that are also set forth below in Table 1. Viscosity of the urethane acrylate composition including the urethane acrylate adduct and other components is measured at 77° F. with a Brookfield® RVT viscometer, both at 10 rpm and 100 rpm to determine the thixotropic index of the composition. The composite structure is prepared by spraying the urethane acrylate composition onto the back side of the preformed first layer along with the fiber.

Adhesion between the first layer and the support layer is measured, in psi, with an Elcometer® adhesion tester. The results of the adhesion test are dependent on the thickness of the support layer, especially when the reactive diluent is absent from the support layer. More specifically, adhesion between the layers is enhanced by softening the first layer. When the reactive diluent is present in the support layer, the reactive diluent softens the first layer. However, when the reactive diluent is absent, heat is required from the support layer to soften the first layer. Support layers having greater thicknesses generate and retain more heat during production than thinner support layers.

For bathware applications, minimum adhesion is preferably about 300 psi. The thickness of the support layer for Examples A-C exhibit adhesion properties that are in excess of the minimum adhesion preferred for bathware. For Example D, the thickness of the support layer was optimized to achieve minimal thickness without the reactive diluent while satisfying the minimum adhesion requirements. Although not specifically included in any of the following examples, it is also to be appreciated that the composite structure may further include a second layer, also described above. Specific components included in the first layer and the support layer, along with the viscosity of the composition including the urethane acrylate adduct prior to reaction, are set forth in Table 1. All amounts are in parts by weight based on the total weight of the respective layer unless otherwise noted.

TABLE 1

| | | | | |
|---|---|---|---|---|
| Component | Ex. A | Ex. B | Ex. C | Ex. D |

First Layer

| | | | | |
|---|---|---|---|---|
| Polymer A | 100 | 0 | 0 | 0 |
| Polymer B | 0 | 100 | 0 | 0 |
| Polymer C | 0 | 0 | 100 | 100 |
| Total | 100.00 | 100.00 | 100.00 | 100.00 |
| Support Layer | | | | |
| Urethane Acrylate Adduct | 33.48 | 33.48 | 33.48 | 47.84 |
| Reactive Diluent A | 5.91 | 5.91 | 5.91 | 0.00 |
| Catalyst A | 0.05 | 0.05 | 0.05 | 0.14 |
| Catalyst B | 0.40 | 0.40 | 0.40 | 0.00 |
| Catalyst C | 0.18 | 0.18 | 0.18 | 0.29 |
| Catalyst D | 0.06 | 0.06 | 0.06 | 0.00 |
| Catalyst E | 0.00 | 0.00 | 0.00 | 1.68 |
| Additive A | 0.40 | 0.40 | 0.40 | 0.00 |
| Additive B | 40.25 | 40.25 | 40.25 | 33.61 |
| Additive C | 1.23 | 1.23 | 1.23 | 0.00 |
| Additive D | 18.03 | 18.03 | 18.03 | 15.97 |
| Additive E | 0.00 | 0.00 | 0.00 | 0.22 |
| Additive F | 0.00 | 0.00 | 0.00 | 0.24 |
| Viscosity, Cps at 10 rpm | 6600 | 6600 | 6600 | N/A |
| Viscosity, Cps at 100 rpm | 1930 | 1930 | 1930 | N/A |
| Gel Time, Minutes | 7:42 | 7:42 | 7:42 | N/A |
| Thickness, inches | 0.125 | 0.125 | 0.125 | 0.098 |
| Adhesion, psi | 1200 | 1200 | 550 | 310 |

Polymer A is a sheet of extruded acrylonitrile styrene acryl ate.

Polymer B is a sheet of extruded acrylonitrile butadiene styrene.

Polymer C is a sheet of cast acrylic.

Urethane Acrylate Adduct is prepared from the reaction of a polymeric diphenylmethane diisocyanate (PMDI) having an actual functionality of about 2.7 and an NCO content of about 31.4 parts by weight based on the total weight of the PMDI and one reactive equivalent of isocyanate, commercially available from BASF Corporation of Wyandotte, Mich., and 98% hydroxyethyl methacrylate (HEMA) having two reactive equivalents of hydroxyl groups, commercially available from Degussa.

Reactive Diluent is methyl methacrylate.

Catalyst A is a 70% solution of potassium octoate commercially available from Air Products and Chemicals, Inc.

Catalyst B is a 40% benzoyl peroxide solution.

Catalyst C is a 12% cobalt solution, commercially available from OMG Americas, Inc.

Catalyst D is N,N-dimethyl-para-toluidine(DMPT), commercially available from RSA.

Catalyst E is cumene hydroperoxide commercially available from Witco.

Additive A is a silicone-based anti-foam agent commercially available from Byk-Chemie.

Additive B is calcium carbonate commercially available from Omya Corporation.

Additive C is 2,2,4-trimethyl-1,3-pentanediol diisobutyrate plasticizer commercially available from Eastman-Kodak.

Additive D is chopped glass having a ½ inch average length, commercially available from Owens-Corning.

Additive E is another silicone-based anti-foam agent commercially available from Byk-Chemie.

Additive F is a fumed silica thixotropic agent.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A composite structure comprising:
(A) a first layer that is a show surface of said composite structure and preformed from a polymer; and
(B) a support layer comprising a urethane acrylate composition including:
I) a urethane acrylate adduct that is the reaction product of:
(a) an isocyanate component having at least two isocyanate groups; and
(b) a stoichiometric excess of a functionalized acrylate component having at least one isocyanate-reactive functional group that is reactive with at least one of said isocyanate groups.
II) a catalyst system comprising:
(a) a peroxide-based catalyst; and
(b) a first metal salt.

2. A composite structure as set forth in claim 1 wherein said polymer comprises a copolymer.

3. A composite structure as set forth in claim 2 wherein said copolymer is selected from the group of styrene acrylonitrile, acrylonitrile styrene acrylate, acrylonitrile styrene alkacrylates, poly(acrylonitrile-co-alkyl acrylate), poly(acrylonitrile-co-alkyl alkacrylate), and combinations thereof

4. A composite structure as set forth in claim 1 wherein said polymer is based on at least one of an acrylonitrile and an acrylate.

5. A composite structure as set forth in claim 4 wherein said polymer is selected from the group of acrylonitrile butadiene styrene, polyalkyl acrylate, polyalkyl alkacrylate, and combinations thereof.

6. A composite structure as set forth in claim 4 wherein said polymer is an acrylic polymer.

7. A composite structure as set forth in claim 1 wherein said preformed first layer is formed through a thermoforming process in an open mold.

8. A composite structure as set forth in claim 1 wherein said first metal salt comprises cobalt carboxylate.

9. A composite structure as set forth in claim 1 wherein said peroxide-based catalyst comprises benzoyl peroxide.

10. A composite structure as set forth in claim 9 further comprising an accelerator.

11. A composite structure as set forth in claim 10 wherein said accelerator comprises an amine.

12. A composite structure as set forth in claim 1 wherein said peroxide-based catalyst comprises cumene hydroperoxide.

13. A composite structure as set forth in claim 1 further comprising a second metal salt.

14. A composite structure as set forth in claim 13 wherein said second metal salt comprises potassium octoate.

15. A composite structure as set forth in claim 1 further comprising an accelerator.

16. A composite structure as set forth in claim 15 wherein said accelerator comprises N,N-dimethyl-p-toluidine.

17. A composite structure as set forth in claim 15 wherein said accelerator comprises diethyl aniline.

18. A composite structure as set forth in claim 15 wherein said accelerator comprises dimethyl aniline.

19. A composite structure as set forth in claim 1 wherein said isocyanate-reactive functional group is selected from the group of hydroxy-functional groups, amine-functional groups, and combinations thereof.

20. A composite structure as set forth in claim 19 wherein said functionalized acrylate component has from one to four isocyanate-reactive functional groups.

21. A composite structure as set forth in claim 1 wherein said isocyanate-reactive functional group comprises a hydroxy-functional group.

22. A composite structure as set forth in claim 21 wherein said hydroxy-functional group has an alkacrylate unit having from one to twenty carbon atoms.

23. A composite structure as set forth in claim 21 wherein said functionalized acrylate component has an alkacrylate unit that has at least one alkyl group having from one to twenty carbon atoms.

24. A composite structure as set forth in claim 1 wherein said stoichiometric excess of said functionalized acrylate component is further defined as a range of molar equivalent ratios of said functionalized acrylate component to said isocyanate component of from 3:1 to 1.05:1.

25. A composite structure as set forth in claim 1 wherein said isocyanate component has an average of from two to three isocyanate groups.

26. A composite structure as set forth in claim 25 wherein said isocyanate component is selected from the group of toluene diisocyanates, polymeric phenylmethane polyisocyanates diisocyanates, diphenylmethane diisocyanates, aliphatic isocyanates, isocyanate-based prepolymers, modified isocyanates, and combinations thereof.

27. A composite structure as set forth in claim 1 wherein said support layer further comprises a reactive diluent having at least one acrylate-reactive functional group selected from the group of vinyl groups, allyl groups, cyclic allyl groups, cyclic vinyl groups, acrylic groups, functionalized acrylate groups, acrylamide groups, acrylonitrile groups, and combinations thereof.

28. A composite structure as set forth in claim 27 wherein said reactive diluent is selected from the group of styrene, divinyl benzene, allyl alkylacrylates, vinyl toluene, diacetone acrylamide, acrylonitrile, hydroxyethyl methacrylate, hydroxypropyl methacrylate, alpha methyl styrene, butyl styrene, methyl methacrylate, monochlorostyrene and combinations thereof.

29. A composite structure as set forth in claim 27 wherein said reactive diluent and said urethane acrylate adduct are present in a weight ratio of at least 0.01:1.

30. A composite structure as set forth in claim 1 wherein said support layer further comprises a fiber.

31. A composite structure as set forth in claim 30 wherein said fiber is selected from the group of chopped fiberglass, chopped carbon fibers, chopped wood fibers, chopped aramid fibers including all aromatic polyamide materials, chopped polymer fibers such as nylon, and combinations thereof.

32. A composite structure as set forth in claim 1 wherein said support layer further comprises at least one additive selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, gel time retarders, and combinations thereof.

33. A composite structure as set forth in claim 1 wherein said support layer has a thickness of at least 0.04 inches.

34. A composite structure as set forth in claim 1 further including a second layer disposed between said first layer and said support layer.

35. A composite structure as set forth in claim 34 wherein said second layer comprises a second urethane acrylate adduct.

36. A composite structure as set forth in claim 35 wherein said second urethane acrylate adduct is the same as said urethane acrylate adduct of said support layer.
